(19) United States
(12) Patent Application Publication
(10) Pub. No.: US 2025/0086979 A1
(43) Pub. Date: Mar. 13, 2025

(54) GRAPH NEURAL NETWORK (GNN) IMPLEMENTED MULTI-MODAL SPATIOTEMPORAL FUSION

(71) Applicant: QUALCOMM Incorporated, San Diego, CA (US)

(72) Inventors: Venkatraman Narayanan, Farmington Hills, MI (US); Varun Ravi Kumar, San Diego, CA (US); Senthil Kumar Yogamani, Headford (IE)

(21) Appl. No.: 18/463,109

(22) Filed: Sep. 7, 2023

(51) Int. Cl. G06V 20/58; G06V 10/80; G06V 10/82

(52) U.S. Cl. CPC G06V 20/58; G06V 10/806; G06V 10/82

(57) ABSTRACT

Systems that support graph neural network (GNN) implemented multi-modal spatiotemporal fusion are provided. Identifying and tracking an object in images captured by an imaging system is facilitated by generating a graph based on multimodal data received from a plurality of sensors. The graph encodes spatial components and spatial data associated with the images and encodes temporal data associated with the images. Pooled features are generated, through application of a first graph attention network (GAT), by pooling spatial features and temporal features. The spatial features are based on the spatial component and on the spatial relationship, and the temporal features are based on the temporal relationship. A three dimensional bounding box associated with the object is decoded by propagating the pooled features through a fully connected layer.

### TECHNICAL FIELD

Aspects of the present disclosure relate generally to driver-operated or driver-assisted vehicles, and more particularly, to methods and systems suitable for supplying driving assistance or for autonomous driving through graph neural network (GNN) implemented multi-modal spatiotemporal fusion.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, blind spot detection, three dimensional (3D) object detection, 3D object tracking, or combinations thereof.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. For instance, an object, such as a person, may suddenly and unexpectedly appear in a road in front of the vehicle. Accordingly, aspects of this disclosure, provide improved systems for assisting drivers in vehicles with enhanced situational awareness when driving on the road, alternatively, providing automated vehicles with enhanced situational awareness when driving on the road, or a combination thereof. In particular, aspects of this disclosure facilitate identification, by the vehicle, of an object, tracking of the object over a period of time, or a combination thereof.

Conventional techniques Ito implement 3D object detection, 3D object tracking, or both exhibit many drawbacks. For example, recurrent architectures, such as long short-term memory networks (LSTMs), have been deployed, but LSTMs are slow, difficult to train, and difficult to stabilize. Transformers also have been used in 3D object detection, 3D object tracking, or both. However, transformers often exhibit the same problems as LSTMs and, additionally, often provide inaccurate results, imprecise results, or both.

Example embodiments according to this disclosure provide graph neural network (GNN) implemented multi-modal spatiotemporal fusion. To implement the foregoing, a graph is generated based on first data received from a first sensor and based on second data received from a second sensor. Each node of the graph may represent a spatial component of one or more encoded features associated with the object. The spatial component may be indicated by the first data and by the second data. Additionally, each edge of the graph may represent a temporal relationship among a plurality of nodes of the graph, a spatial relationship among the plurality of nodes, or a combination thereof.

Further, pooled features may be generated through application of a first graph attention network (GAT). The pooled features may be generated by pooling spatial features and temporal features. The spatial features may be based on the spatial component and on the spatial relationship. Additionally, the temporal features may be based on the temporal relationship. A three dimensional (3D) bounding box associated with the object may be decoded by propagating the pooled features through a fully connected (FC) layer. Based on the 3D bounding box, the vehicle may be configured to adjust its direction of travel, such as to avoid the object.

In one aspect of the disclosure, a method for identifying and tracking an object in images captured by an imaging system of a vehicle includes generating a graph based on first data received from a first sensor of a first modality and second data received from a second sensor of a second modality. Each node of the graph represents a spatial component of one or more encoded features associated with the object. The spatial component is indicated by the first data and by the second data, and each edge of the graph represents a temporal relationship among a plurality of nodes of the graph, a spatial relationship among the plurality of nodes, or a combination thereof. Additionally, the method includes generating pooled features, through application of a first graph attention network (GAT), by pooling spatial features and temporal features. The spatial features may be based on the spatial component and the spatial relationship, and the temporal features may be based on the temporal relationship. Moreover, the method includes decoding a three dimensional (3D) bounding box associated with the object by propagating the pooled features through a fully connected (FC) layer.

In an additional aspect of the disclosure, an apparatus includes a processing system associated with a vehicle. The processing system including one or more processors and one or more memories coupled with the one or more processors, the processing system configured to generate a graph based on first data received from a first sensor of a first modality and second data received from a second sensor of a second modality. Each node of the graph represents a spatial component of one or more encoded features associated with an object, the spatial component indicated by the first data and by the second data. Additionally, each edge of the graph represents a temporal relationship among a plurality of nodes of the graph, a spatial relationship among the plurality of nodes, or a combination thereof. Further, the processing system is configured to generate pooled features, through application of a first graph attention network (GAT). To generate the pooled features, the processing system is configured to pool spatial features and temporal features. The spatial features may be based on the spatial component and the spatial relationship, and the temporal features may be based on the temporal relationship. Moreover, the processor system is configured to decode a three dimensional (3D) bounding box associated with the object by propagating the pooled features through a fully connected (FC) layer.

In an additional aspect of the disclosure, a non-transitory computer-readable medium stores instructions that, when executed by a processor, cause the processor to perform operations. The operations include generating a graph based on first data received from a first sensor of a first modality and second data received from a second sensor of a second modality. Each node of the graph represents a spatial component of one or more encoded features associated with an object. The spatial component is indicated by the first data and by the second data, and each edge of the graph represents a temporal relationship among a plurality of nodes of the graph, a spatial relationship among the plurality of nodes, or a combination thereof. Additionally, the operations include generating pooled features, through application of a first graph attention network (GAT), by pooling spatial features and temporal features. The spatial features may be based on the spatial component and the spatial relationship, and the temporal features may be based on the temporal relationship. Moreover, the operations include decoding a three dimensional (3D) bounding box associated with the object by propagating the pooled features through a fully connected (FC) layer.

In an additional aspect of the disclosure, a vehicle includes a first sensor of a first modality, a second sensor of a second modality distinct from the first modality, and a processing system. The processing system is configured to generate a graph based on first data received from a first sensor and second data received from a second sensor. Each node of the graph represents a spatial component of one or more encoded features associated with an object, the spatial component indicated by the first data and by the second data. Additionally, each edge of the graph represents a temporal relationship among a plurality of nodes of the graph, a spatial relationship among the plurality of nodes, or a combination thereof. Further, the processing system is configured to generate pooled features, through application of a first graph attention network (GAT). To generate the pooled features, the processing system is configured to pool spatial features and temporal features. The spatial features may be based on the spatial component and the spatial relationship, and the temporal features may be based on the temporal relationship. Moreover, the processor system is configured to decode a three dimensional (3D) bounding box associated with the object by propagating the pooled features through a fully connected (FC) layer.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a graph neural network (GNN) implemented multi-modal spatiotemporal fusion system according to one or more aspects of the disclosure.

FIG. 5 is a block diagram illustrating a GNN implemented multi-modal spatiotemporal fusion process according to one or more aspects of the disclosure.

FIG. 6 is a block diagram illustrating components of a GNN implemented multi-modal spatiotemporal fusion process according to one or more aspects of the disclosure.

FIG. 7 is a flow chart illustrating an example method for multi-modal spatiotemporal fusion according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support GNN implemented multi-modal spatiotemporal fusion, such as to facilitate, by a vehicle, identification of an object (e.g., that might appear in front of the vehicle), tracking of the object over time, or both. According, to achieve the foregoing, a graph is generated based on first data received from a first sensor and based on second data received from a second sensor. In some implementations, the first sensor and the second senor may be incorporated into or may be a part of the vehicle. The first sensor may be of a first modality distinct from a second modality of the second sensor. For instance, the first sensor may be configured to capture light detection and ranging (LiDAR) point clouds from images of an object to be identified, to be tracked over a period of time, or both, while the second sensor may be configured to capture pixelated images of the object. Each node of the graph may represent a spatial component of one or more encoded features associated with the object. The spatial component may be indicated by the first data and by the second data. Additionally, each edge of the graph may represent a temporal relationship among a plurality of nodes of the graph, a spatial relationship among the plurality of nodes, or a combination thereof.

Further, pooled features may be generated through application of a first graph attention network (GAT). The pooled features may be generated by pooling spatial features and temporal features. The spatial features may be obtained by propagating the spatial component and spatial data, indicating the spatial relationship, through a graph neural network (GNN) via stacked layers of a second GAT. The temporal features obtained by propagating temporal data, indicating the temporal relationship, through the GNN via stacked layers of a temporal convolution network (TCN). A three dimensional (3D) bounding box associated with the object may be decoded by propagating the pooled features through a fully connected (FC) layer.

In 3D object detection, 3D object tracking, or both, data from different sensor modalities often is fused in space and in time. For example, vehicles often are equipped with different types of sensors, such as light detection and ranging (LiDAR) sensors and cameras that generate different data modalities. In particular, LiDAR sensors often generate LiDAR point clouds, while cameras usually generate pixelated images. Additionally, the sensors may capture data from different spatial vantages (e.g., different angles, different positions, etc.), the data may be captured at different instances of time, or a combination thereof. Accordingly, to detect an object, to track and object, or both, different types of data, such as LiDAR point clouds or images, usually are combined. Further, data is usually combined spatiotemporally, so that data at different time instances and captured from different vantages is fused.

Typical techniques to implement spatiotemporal fusion include a bipartite approach in which a convolutional neural network (CNN), a vision transformer, or both extract 3D spatial features from multi-modal sensor data and then apply recurrent architectures, such as long short-term memory networks (LSTMs), to identify and track temporal features. Problems with this bipartite approach include that it is slow, and the recurrent architectures (e.g., the recurrent neural networks) are difficult to train and to stabilize. Another approach to spatiotemporal fusion of multimodal sensor data includes application of restricted transformer modules to encode both spatial and temporal features. Problems with transformers include that they are unstable and slow. Additionally, transformers exclude significant portions of spatiotemporal data, with the result that object identification, object tracking, or both implemented through application of transformers often is inaccurate, imprecise, or a combination of both.

Particular implementations of the subject matter described in this disclosure may be implemented to realize one or more of the following potential advantages or benefits. In some aspects, the present disclosure provides techniques for image processing that may be particularly beneficial in smart vehicle applications by facilitating the rapid, accurate, and precise identification of one or more objects, the tracking, over a period of time, of the one or more objects, or both. For example, GNN implemented multi-modal spatiotemporal fusion may enhance an accuracy, a precision, or both with which a vehicle, such as an autonomous or a partially autonomous vehicle, may identify an object, track an object over time, or both. To illustrate, by pooling spatial features and temporal features and by decoding a 3D bounding box associated with the object based on the pooled features, enhanced accuracy, enhanced precision, or both may be achieved, since spatial information associated with the object, temporal information associated with the object, and different modalities of sensor information all are analyzed to identify the object, to track the object over time, or both. In contrast, prior art systems, such as transformers, usually fail to account for large segments of data, thereby generating inaccurate and imprecise results.

Moreover, generating a graph that encodes spatiotemporal relationships among encoded features associated with the object and that is based on multi-modal sensor data enhances an accuracy and a precision with which an object may be identified, tracked over time or both. To elaborate, prior art systems, such as transformers, are optimized for processing sequential data, such as text. In contrast, the disclosed GNN implemented multi-modal spatiotemporal fusion technique facilitates the processing of complex, heterogenous data that is spatiotemporally related by organizing the data in a graph that may be efficiently processed through a GNN.

Additionally, GNN implemented multi-modal spatiotemporal fusion may conserve computational resources, thereby improving a computational efficiency with which an object may be identified, tracked over time, or both thus resulting in reduced power consumption. For example, bifurcating an object identification or tracking task into a spatial encoding task to extract spatial features from a graph and a separate temporal encoding task to extract temporal features from the graph may be more computationally efficient than concurrently and jointly processing the spatiotemporal features. Since the pooled features, from which a 3D bounding box is instantiated, are generated based on the spatial features and the temporal features, object identification, object tracking, or both are rendered computationally efficient through application of GNN implemented multi-modal spatiotemporal fusion. Additionally, since fewer computational resources may be deployed than if the 3D bounding box were generated by jointly and concurrently processing the spatiotemporal features, the GNN implemented multi-modal spatiotemporal fusion may also conserve power, which is particularly advantageous for battery powered vehicles.

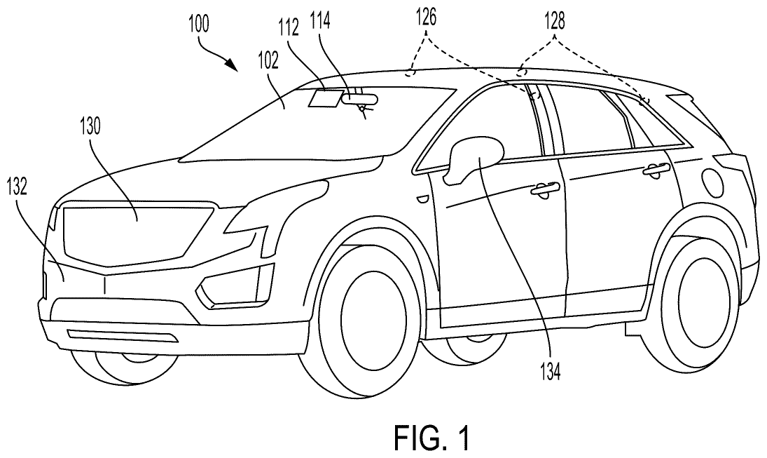

FIG. 1 is a perspective view of a motor vehicle with a driver monitoring system according to embodiments of this disclosure. Vehicle 100 may include front-facing camera 112 mounted inside the cabin looking through windshield 102. Vehicle 100 may also include cabin-facing camera 114 mounted inside the cabin looking towards occupants of vehicle 100, and in particular the driver of vehicle 100. Although one set of mounting positions for cameras 112 and 114 are shown for vehicle 100, other mounting locations may be used for cameras 112 and 114. For example, one or more cameras may be mounted on one of the driver or passenger B pillars 126 or one of the driver or passenger C pillars 128, such as near the top of pillars 126 or 128. As another example, one or more cameras may be mounted at the front of vehicle 100, such as behind radiator grill 130 or integrated with bumper 132. As a further example, one or more cameras may be mounted as part of a driver or passenger side mirror assembly 134.

Camera 112 may be oriented such that the field of view of camera 112 captures a scene in front of vehicle 100 in the direction that vehicle 100 is moving when in drive mode or forward direction. In some embodiments, an additional camera may be located at the rear of vehicle 100 and oriented such that the field of view of the additional camera captures a scene behind vehicle 100 in the direction that vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of vehicle 100. Thus, the benefits obtained while the operator is driving vehicle 100 in a forward direction may likewise be obtained while the operator is driving vehicle 100 in a reverse direction.

Further, although embodiments of the disclosure may be described with reference a “front-facing” camera, referring to camera 112, aspects of the disclosure may be applied similarly to an input received from an array of cameras mounted around vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

Camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

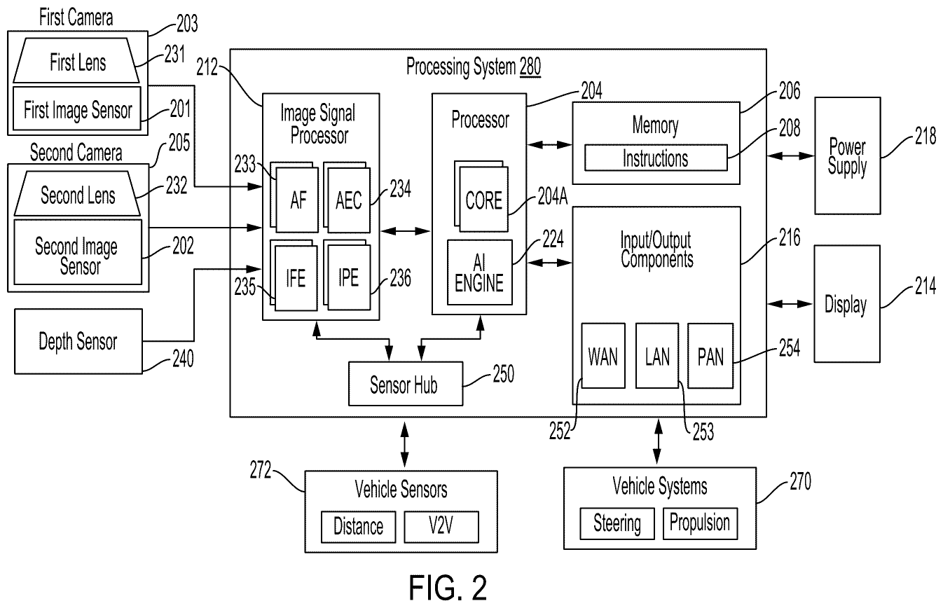

FIG. 2 shows a block diagram of an example image processing configuration for a vehicle according to one or more aspects of the disclosure. Vehicle 100 may include, or otherwise be coupled to, processing system 280. Processing system 280 may include image signal processor 212, processor 204, memory 206, input/output (I/O) components 216, and sensor hub 250. Image signal processor 212 may include functionality for processing image frames from one or more image sensors, such as first image sensor 201, second image sensor 202, and depth sensor 240. Vehicle 100 may also include or be coupled to display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of wide area network (WAN) adaptor 252, local area network (LAN) adaptor 253, and/or personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of adaptors 252, 253, and/or 254 may be coupled to an antenna, including multiple antennas configured for primary and diversity reception and/or configured for receiving specific frequency bands. Vehicle 100 may further include or be coupled to power supply 218, such as a battery or an alternator. Vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between image sensors 201 and 202 and image signal processor 212.

Vehicle 100 may include sensor hub 250 for interfacing with sensors to receive data regarding movement of vehicle 100, data regarding an environment around vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

Image signal processor (ISP) 212 may receive image data, such as used to form image frames. In one embodiment, a local bus connection couples image signal processor 212 to image sensors 201 and 202 of first camera 203, which may correspond to camera 112 of FIG. 1, and second camera 205, which may correspond to camera 114 of FIG. 1, respectively. In another embodiment, a wire interface may couple image signal processor 212 to an external image sensor. In a further embodiment, a wireless interface may couple image signal processor 212 to image sensor 201, 202.

First camera 203 may include first image sensor 201 and corresponding first lens 231. Second camera 205 may include second image sensor 202 and corresponding second lens 232. Each of lenses 231 and 232 may be controlled by associated autofocus (AF) algorithm 233 executing in ISP 212, which adjust lenses 231 and 232 to focus on a particular focal plane at a certain scene depth from image sensors 201 and 202. AF algorithm 233 may be assisted by depth sensor 240. In some embodiments, lenses 231 and 232 may have a fixed focus.

First image sensor 201 and second image sensor 202 are configured to capture one or more image frames. Lenses 231 and 232 focus light at image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, image signal processor 212 may execute instructions from a memory, such as instructions 208 from memory 206, instructions stored in a separate memory coupled to or included in image signal processor 212, or instructions provided by processor 204. In addition, or in the alternative, image signal processor 212 may include specific hardware (such as one or more integrated circuits (ICs)) configured to perform one or more operations described in the present disclosure. For example, image signal processor 212 may include one or more image front ends (IFEs) 235, one or more image post-processing engines (IPEs) 236, and or one or more auto exposure compensation (AEC) 234 engines. AF 233, AEC 234, IFE 235, IPE 236 may each include application-specific circuitry, be embodied as software code executed by ISP 212, and/or a combination of hardware within and software code executing on the ISP 212.

In some implementations, memory 206 may include a non-transient or non-transitory computer readable medium storing computer-executable instructions 208 to perform all or a portion of one or more operations described in this disclosure. In some implementations, instructions 208 include a camera application (or other suitable application) to be executed during operation of vehicle 100 for generating images or videos. Instructions 208 may also include other applications or programs executed for vehicle 100, such as an operating system, mapping applications, or entertainment applications. Execution of the camera application, such as by processor 204, may cause vehicle 100 to generate images using image sensors 201 and 202 and image signal processor 212. Memory 206 may also be accessed by image signal processor 212 to store processed frames or may be accessed by processor 204 to obtain the processed frames. In some embodiments, vehicle 100 includes a system on chip (SoC) that incorporates image signal processor 212, processor 204, sensor hub 250, memory 206, and input/output components 216 into a single package.

In some embodiments, at least one of image signal processor 212 or processor 204 executes instructions to perform various operations described herein, including object detection, risk map generation, driver monitoring, and driver alert operations. For example, execution of the instructions can instruct image signal processor 212 to begin or end capturing an image frame or a sequence of image frames. In some embodiments, processor 204 may include one or more general-purpose processor cores 204A capable of executing scripts or instructions of one or more software programs, such as instructions 208 stored within memory 206. For example, processor 204 may include one or more application processors configured to execute the camera application (or other suitable application for generating images or video) stored in memory 206.

In executing the camera application, processor 204 may be configured to instruct image signal processor 212 to perform one or more operations with reference to image sensors 201 or 202. For example, the camera application may receive a command to begin a video preview display upon which a video comprising a sequence of image frames is captured and processed from one or more image sensors 201 or 202 and displayed on an informational display on display 114 in the cabin of vehicle 100.

In some embodiments, processor 204 may include ICs or other hardware (e.g., an artificial intelligence (AI) engine 224) in addition to the ability to execute software to cause vehicle 100 to perform a number of functions or operations, such as the operations described herein. In some other embodiments, vehicle 100 does not include processor 204, such as when all of the described functionality is configured in image signal processor 212.

In some embodiments, display 214 may include one or more suitable displays or screens allowing for user interaction and/or to present items to a user, such as a preview of the image frames being captured by image sensors 201 and 202. In some embodiments, display 214 is a touch-sensitive display. I/O components 216 may be or include any suitable mechanism, interface, or device to receive input (such as commands) from the user and to provide output to the user through display 214. For example, I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via processor 204, components (such as processor 204, memory 206, image signal processor 212, display 214, and I/O components 216) may be coupled to each another in other various arrangements, such as via one or more local buses, which are not shown for simplicity. While image signal processor 212 is illustrated as separate from processor 204, image signal processor 212 may be a core of processor 204 that is an application processor unit (APU), included in a system on chip (SoC), or otherwise included with processor 204. While vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including vehicle 100.

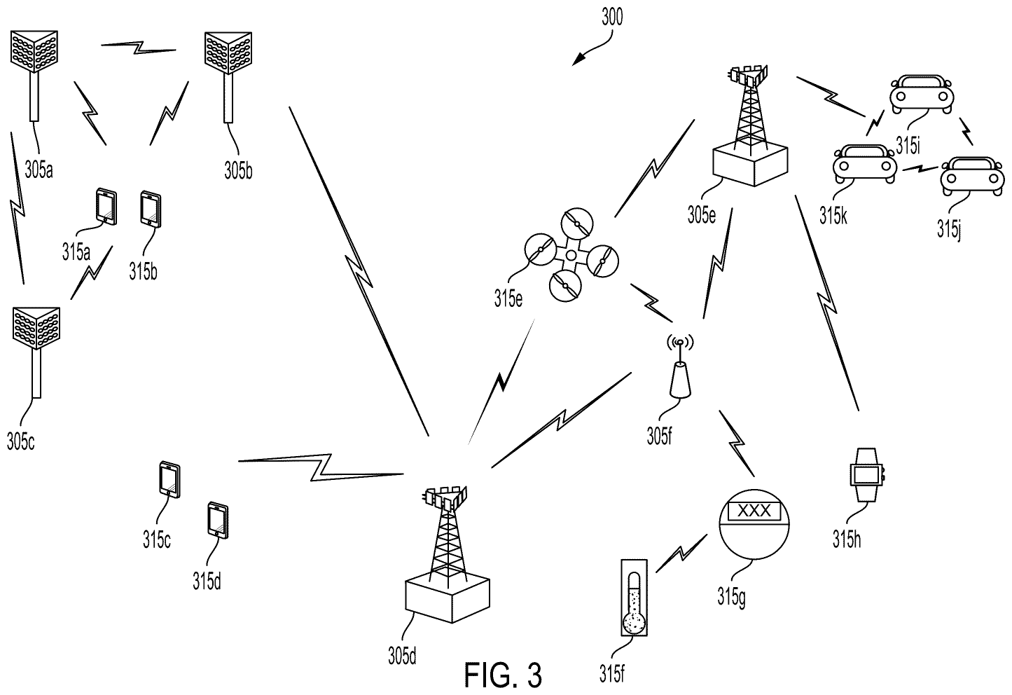

Vehicle 100 may communicate as a user equipment (UE) within wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

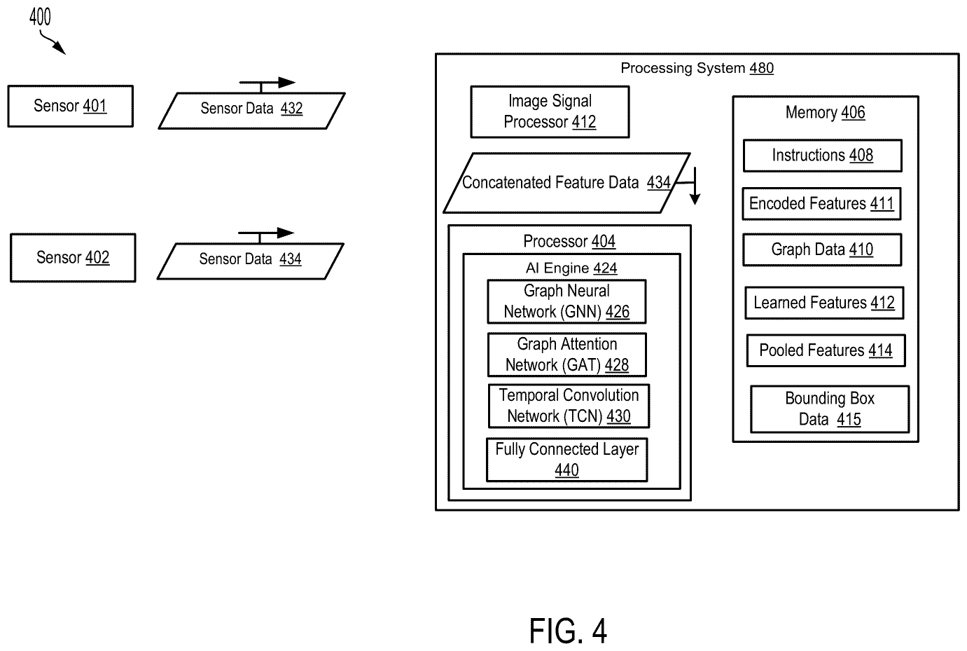

A vehicle UE with a processing system may implement multi-modal spatiotemporal fusion for improved 3D object detection and object tracking such as shown in FIG. 4. FIG. 4 is a block diagram illustrating GNN implemented multi-modal spatiotemporal fusion system 400 according to one or more aspects of the disclosure. GNN implemented multi-modal spatiotemporal fusion system 400 includes sensors 401, 402 and processing system 480. Sensors 401, 402 may include or correspond to first image sensor 201, second image sensor 202, or a combination thereof. In implementations, sensor 401 may include or correspond to LiDAR, while sensor 402 may include or correspond to an image capturing device of a different modality, such as a camera. It is understood that sensors 401, 402 may be any type of sensors capable of generating different types of images using different modalities. For instance, sensor 401 may generate images using a first modality (e.g., LiDAR, radar, pixelated images, etc.) while sensor 402 may generate images using a second modality (e.g., the other of LiDAR, radar, pixelated images, etc.) distinct from the first modality.

Processing system 480 may include or correspond to processing system 280. Processing system 480 includes image signal processor 412, processor 404, and memory 406. Image signal processor 412 may include or correspond to image signal processor 212, processor 404 may include or correspond to processor 204, and memory 406 may include or correspond to memory 206. Processor 404 and image signal processor 412 may be referred to interchangeably such that references to processor 404 include image signal processor 412 and vice versa.

Memory 406 includes instructions 408, encoded features 411, graph data 410, learned features 412, pooled features 414, and bounding box data 415. Instructions 408 may include or correspond to instructions 208. Additionally, instructions 408 may include code, executable by processor 404, to instantiate AI engine 424.

Encoded features 411 may include or correspond to encoded data, extracted from sensor data 432, 434, associated with one or more images of an object to be identified, to be tracked over time, or both. As an example, the object may include or correspond to any object that a vehicle is likely to encounter, such as a person, other vehicles, and the like. Additionally, encoded features 411 may correspond to bird's eye view (BEV) features associated with the object and captured in or encoded by sensor data 432, 434. Encoded features 411 may be stored in the form of one or more feature vectors. However, other data structures may be used to store features 411. For instance, a matrix may be used to store data corresponding to features 411.

Graph data 410 may include encoded features extracted from sensor data 432, 434, encoded features 411, or both and configured into a graph. The nodes of the graph may represent a spatial component of one or more encoded features 411 extracted from sensor data 432, 434 and that are associated with an object, such as an object in one or more fields of view of vehicle 200 that is to be identified, tracked over time, or both. The edges of the graph may represent a temporal relationship between at least two nodes of the graph, among a plurality of nodes of the graph, or both. Additionally, the edges of the graph may represent a spatial relationship between at least two nodes of the graph, among the plurality of nodes of the graph, or a combination thereof. Accordingly, graph data 410 may further include spatial data, corresponding to the spatial relationship between the at least two nodes, among the plurality of nodes, or both. Further, graph data 410 may include temporal data, corresponding to the temporal relationship between the at least two nodes, among the plurality of nodes, or both.

Learned features 412 may include or correspond to spatial features, also referred to as learned spatial features, obtained based on propagating the spatial component, the spatial data, or both through a GNN via stacked layers of a first GAT. Additionally, learned features 412 may include or correspond to temporal features, also referred to as learned temporal features, obtained based on propagating temporal data through the GNN via stacked layers of a temporal convolution network (TCN). Pooled features 414 may be include or correspond to a combination of the spatial features and the temporal features generated based on a second GAT. Pooled features 414 may be stored in the form of a pooled feature vector. However, other data structures may be used to store pooled features 414. For instance, data corresponding to pooled features 414 may be stored in a matrix.

Bounding box data 415 may include data associated with a bounding box superimposed over the object to be identified, tracked over time, or both. Bounding box data 415 may include a center location of the bounding box, a size of the bounding box, or a combination thereof. For instance, bounding box data 415 may include a first value associated with a length of the bounding box, a second value associated with the width of the bounding box, and a third value associated with the depth of the bounding box.

Processor 404 may include AI engine 424. In implementations, AI engine 424 may be software or firmware implemented by processor 404; one or more hardware components of processor 404, such as one or more graphical processing units (GPUs), one or more central processing units (CPUs), one or more field programmable gate arrays (FPGAs), or a combination thereof; one or more application specific integrated circuits (ASICs); or any combination thereof. While AI engine 424 is depicted as being implemented by or associated with processor 404, in implementations, AI engine 424 may be associated with (e.g., may be a component of) or implemented by image signal processor 412. AI engine 424 may be configured to implement GNN 426, GAT 428, TCN 430, and fully connected (FC) layer 440. GNN 426, GAT 428, TCN 430, and FC layer 440 may be instantiated by processor 404 to perform one or more of the functions described herein.

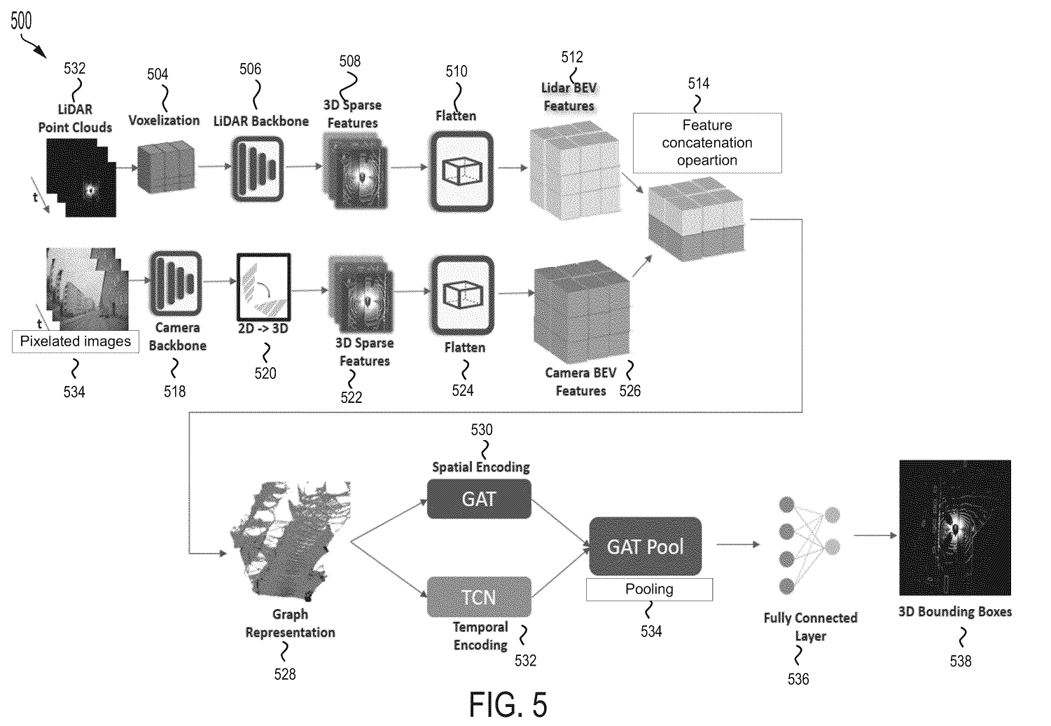

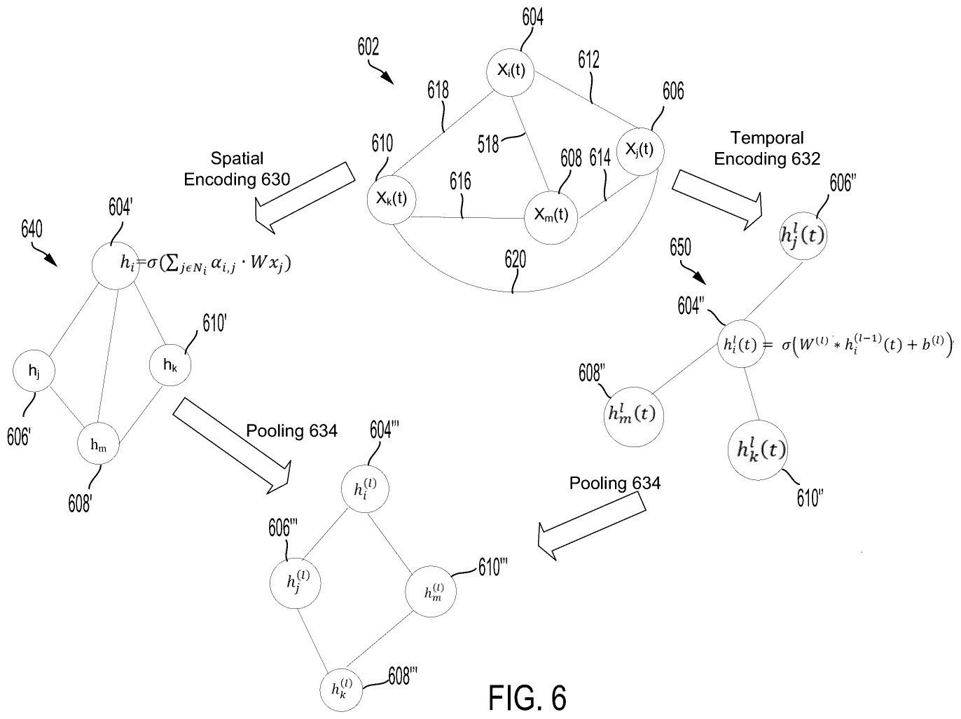

A single cycle of operation of multi-modal spatiotemporal fusion system 400 is represented in the context of FIGS. 5-6, although it should be understood that the process can be performed multiple times or in real-time to update models and/or update 3D bounding boxes. FIGS. 5 and 6 are block diagrams illustrating a GNN implemented multi-modal spatiotemporal fusion process 500, 600 according to one or more aspects of the disclosure.

During a cycle of operation, processing system 480 may receive sensor data 432, 532, 434, 534 from sensors 401, 402. Sensor 401 may operate in a first mode, while sensor 402 may operate in a second mode distinct from the first mode. For example, sensor 401 may include or correspond to LiDAR, while sensor 402 may include or correspond to an image capturing device, such as a camera. Accordingly, sensor data 432 may include or correspond to first modal data, such as one or more LiDAR point clouds 532, while sensor data 434 may include or correspond to second modal data, such as one or more pixelated images 534. It is understood that one or more of sensor 401, sensor 402, or a combination thereof may include or correspond to other types of sensors and are not limited to LiDAR and cameras, respectively. For instance, sensor 401 may include or correspond to radar, while sensor 402 may include or correspond to an infrared (IR) sensor. Further, it is understood that a plurality of different sensors may be used in combination and that the two sensors described with respect to FIG. 4 are for illustrative purposes only.

Image signal processor 412, processor 404, or both may be configured to process sensor data 432, 434. For instance, with regard to sensor data 432 that may include or correspond to a LiDAR point cloud, image signal processor 412, processor 404, or both may be configured to perform voxelization operation 504, voxelizing one or more LiDAR point clouds 532. Additionally, image signal processor 412, processor 404, or both may pass voxels generated through performance of voxelization operation 504 to LiDAR backbone 506. In some implementations, LiDAR backbone 506 may be configured to extract three dimensional (3D) sparse features 508 from the voxels generated via voxelization process 504; however, in other implementations, the foregoing process may be executed by image signal processor 412, processor 404, or both. Moreover, image signal processor 412, processor 404, or both may perform flattening operation 510 to flatten the 3D sparse features to 2D space, thereby reducing a dimensionality of the data and enhancing a computational efficiency with which the data may be processed. Further, image signal processor 412, processor 404, or both may be configured to generate LiDAR bird's eye view (BEV) features 512 from the flattened 3D sparse features.

Sensor data 434 that may include or correspond to pixelated images 534 may be provided to camera backbone 518, which may be configured to convert the 2D images to 3D images. Further, image signal processor 412, processor 404, or both may be configured to convert the 3D images to 3D sparse features 522, which may be flatted, via flattening operation 524, by reducing the images to 2D space. Additionally, image signal processor 412, processor 404, or both may generate camera BEV features 526 from the flatted 3D sparse features. Further, image signal processor 412, processor 404, or both may be configured to perform feature concatenation operation 514, concatenating the LiDAR BEV features 512 and the camera BEV features 526 into concatenated BEV features. In some implementations, image signal processor 412 may be configured to provide concatenated feature data 434 that may include or correspond to the concatenated LiDAR BEV features 512 and camera BEV features 526 to processor 404. LiDAR BEV features 512, camera BEV features 526, concatenated feature data 434, or combinations thereof may be stored in memory 406 as encoded features 411.

Processor 404 or AI engine 424 may be configured to generate graph representation 528, 602 of encoded features 411. One example of graph representation 528 is shown in FIG. 6. Referring to FIG. 6, graph representation 602 includes nodes 604-610 and edges 612-620. Nodes 604-610 represent or encode a spatial component of encoded features 411, and edges 612-620 represent or encode temporal relationships among nodes 604-610, spatial relationships among nodes 604-610, or a combination thereof. As an example, a spatial component of an encoded feature 411 may include or correspond to a 3D space associated with the feature. To illustrate, if the object corresponds to a person in a field of view of the vehicle, the spatial component of an encoded feature 411 may include or correspond to 3D points corresponding to various vantages from which sensors 401, 402 captured sensor data 432, 434 associated with the person. Spatial relationships among nodes 604-610 may indicate how spatial components of nodes 604-610 may be related to one another. For instance, features corresponding to a person's right arm may be spatially related to one another, while features corresponding to a person's left arm may not be spatially related to features corresponding to the person's right arm.

Since sensors 401, 402 may be configured to capture sensor data 432, 434 at different instances of time, sensor data 432, 434 may include time stamps at which sensor data 432, 434 was captured. Accordingly, temporal relationships may include or correspond to temporal relationships among instantiations of sensor data 432, 434. To illustrate, temporal relationships may indicate that a first instantiation of sensor data 432 was captured at a different instance of time that a second instantiation of sensor data 434.

Additionally, each node 604-610 may be associated with a feature vector that stores multi-modal features extracted from sensors 401, 402 at a time t. To elaborate, the multi-modal features may include or correspond to encoded features 411. For instance, node 604 (also referred to as node i) may be associated with feature vector xᵢ(t), and node 608 (also referred to as node m) may be associated with feature vector xₘ(t). Data corresponding to graph representation 528, 602 may be stored in memory 406 as graph data 410. For instance, graph data 410 may include or correspond to data associated with nodes 604-610, edges 612-620, feature vectors associated with nodes 604-610, or combinations thereof.

Operating on graph data 410 extracted from graph representation 528, 602, processor 404 may be configured to execute spatial encoding 530, 630, temporal encoding 532, 632, pooling 534, 634, or combinations thereof. Through performance of spatial encoding 530, 630, processor 404 may be configured to obtain spatial features, also referred to as learned spatial features, to identify a spatial relationship between at least two nodes, a spatial relationship among a plurality of nodes, or a combination thereof. Learned spatial features may include or correspond to spatial elements of graph representation 528, 602 as depicted in spatial graph 640. For example, the spatial elements of graph representation 528, 602 may include or correspond to a spatial component of one or more nodes 604-610, a spatial relationship encoded in one or more edges 612-620 (e.g., a spatial relationship between at least two nodes or among a plurality of nodes), or a combination thereof. To elaborate, spatial encoding 530, 630 may extract spatial aspects of graph representation 528, 602 such that the temporal aspects of graph representation 528, 602 may be ignored.

In performing spatial encoding 530, 630, processor 404 may be configured to generate updated feature vectors, also referred to as spatial feature vectors, hᵢ-hₘ for each node 604′-610′. Each updated feature vector hᵢ-hₘ may be based on feature vector xᵢ-xₘ. In some implementations, processor 404 may perform spatial encoding 530, 630 based on a graph attention network, such as GAT 428 instantiated by AI engine 424, and by propagating the spatial component and spatial data, indicating the spatial relationship, through a GNN, such as GNN 426 instantiated by AI engine 424, via stacked layers of the GAT. In this manner, spatial graph 640 depicting only spatial relationships among nodes 604′-610′ may be generated.

Through performance of temporal encoding 532, 632, processor 404 may be configured to obtain temporal features, also referred to as learned temporal features, to identify a temporal relationship between at least two nodes, a temporal relationship among a plurality of nodes, or a combination thereof. Learned temporal features may include or correspond to temporal elements of graph representation 528, 602 as depicted in temporal graph 650. For example, the temporal elements of graph representation 528, 602 may include or correspond to a temporal component of one or more edges 612-620, a temporal relationship between at least two nodes or among a plurality of nodes, or a combination thereof. To elaborate, temporal encoding 532, 632 may extract temporal aspects of graph representation 528, 602 such that the spatial aspects of graph representation 528, 602 are ignored.

In performing temporal encoding 532, 632, processor 404 may be configured to generate updated temporal feature vectors hᵢ^{l}(t)-hₘ^{l}(t) for each node 604″-610″. In some implementations, processor 404 may perform temporal encoding 532, 632 based on a TCN, such as TCN 430 instantiated by AI engine 424, and by propagating the temporal data, indicating the temporal relationship among nodes 604″-610″, through a GNN, such as GNN 426 instantiated by AI engine 424, via the TCN. In this manner, temporal graph 650 depicting only temporal relationships among nodes 604″-610″ may be generated such that spatial information is ignored. Processor 404 may be configured to store learned spatial features, learned temporal features, or both in memory 406 as learned features 412.

Additionally, processor 404 may be configured to perform pooling 534, 634 to pool learned features 412 and to thereby generate a 3D bounding box of an object to be identified, an object to tracked over time, or both. To pool learned features 412, processor 404 may instantiate a second GAT, such as GAT 428, to obtain an attention weight for each node 604′″-610′″ based on a hypothesized importance of each node 604′″-610′″ to predict an object's 3D bounding box. Further, processor 404 may be configured to compute a pooled feature vector corresponding to a weighted sum of feature vectors of each node 604′″-610′″, and further may be configured to decode a 3D bounding box of the object to be identified, to be tracked over time, or both based on the pooled feature vector.

GNN implemented multi-modal spatiotemporal fusion confers several advantages, such as capturing spatial relationships among nodes (e.g., nodes 604-610), temporal relationships among the nodes, and relationships among different modalities of sensor data, such as sensor data 432, 434. In contrast, prior art systems are unable to capture such multimodal spatiotemporal relationships. For example, transformers are suited for processing sequential data, such as text, but are not suited for processing data having non-sequential, complex relationships, such as in the present disclosure.

Another advantage of GNN implemented multi-modal spatiotemporal fusion includes that processing heterogenous multi-modal data, such as data from a plurality of different sensor types. For example, the disclosure facilitates processing of sensor data 432 and sensor data 434, each of which may correspond to a different sensing mode. To illustrate and in some implementations, sensor data 432 may include or correspond to one or more LiDAR point clouds, while sensor data 434 may include or correspond to pixels. It is understood, however, that the foregoing are merely examples, and the GNN implemented multi-modal spatiotemporal fusion technique may be configured to process data from radar, LiDAR, infrared (IR), and other sensors found in or used by vehicles to identify objects, track objects over time, or both. In contrast, prior art systems are unable to efficiently process multi-modal data. For instance, transformers are unable to efficiently process multi-modal data from a plurality of different sensor types.

A further advantage of GNN implemented multi-modal spatiotemporal fusion includes maintaining a memory of latent spatiotemporal relationships among nodes, such as nodes 604-610, once having acquired from graph data, such as graph data 410, information about these relationships, thereby enhancing an overall computational efficiency. To illustrate, the GNN is trained on spatial relationships among nodes 604-610 via spatial encoding 530, 630. Additionally, the GNN is trained on temporal relationships among nodes 604-610 via temporal encoding 530, 632. In this manner, the GNN may apply the acquired spatial learned features, temporal learned features, or both (e.g., the learned features 412) to identify other objects that may overlap an identified object, track other objects over time that may overlap the tracked object, or both. By being able to rely on learned spatial features, temporal features, or both, stored in a memory, such as memory 406, to identify relationships among other nodes, the GNN may conserve computational resources thereby leading to reduced power consumption.

An additional advantage of GNN implemented multi-modal spatiotemporal fusion includes enhanced computational efficiency. To illustrate, in extracting spatial components, spatial relationships, or a combination thereof through performing spatial encoding 530, 630, while ignoring temporal relationships, computational power is conserved, since processor 404 propagates the spatial component and spatial data, indicating the spatial relationship, through a GNN via stacked layers of a first GAT while ignoring temporal components. By ignoring temporal components, a speed with which the spatial components of graph representation 528, 602 are determined may be enhanced. A similar computational efficiency gain may be obtained through temporal encoding 532, 632. Additionally, by conserving computational resources, power also is conserved. Since many vehicles operate on battery power, conserving power may be particularly advantageous.

A further advantage of GNN implemented multi-modal spatiotemporal fusion includes an enhanced precision with which a 3D bounding box associated with an object may be determined, an enhanced accuracy with which the 3D bounding box associated with the object may be determined, or a combination thereof. To elaborate, the disclosure may account for non-linearities in sensor data 432, 434, while prior art systems may be unable to account for such non-linearities. To illustrate, in determining a spatial feature vector for nodes 604-610, the spatial feature vector may include an activation function to account for such non-linearities.

As another example, in pooling 534, 634, nodes, such as nodes 604-610 that are determined to most likely to be of importance in predicting a 3D bounding box are given more weight that nodes 605-610 that are determined to be of less importance in predicting a 3D bounding box. In this manner, by giving more weight to nodes 605-610 that are determined to be of greater importance in predicting a 3D bounding box, enhanced results may be obtained over prior art systems.

In some implementations, to propagate the spatial component and spatial data through GNN 426 and for one or more nodes 604-610, processor 404 may be configured to generate an updated feature vector, also referred to as a spatial feature vector, associated with the one or more nodes 604-610 based on attention coefficients determined from pairs of nodes 604-610 and a feature vector associated with one or more nodes 604-610. For example, a spatial feature vector for node 604 (e.g., node i) may be determined based on the following equation:

$${h}_{i} = σ ( {\sum }_{j ∈ {N}_{i}} {α}_{i , j} \cdot {Wx}_{j} ) .$$

The variable hᵢ represents a spatial feature vector associated with node 604 (e.g., node i), and the variable Nᵢ represents the set of spatial neighbors of node 604 (e.g., node i).

For example, the set of spatial neighbors of node 604 (node i) includes node 606 (node j), node 610 (node k), and node 608 (node m). The variable xⱼ represents the feature vector associated with node 606 (node j), and the variable W represents a learnable matrix configured to transform encoded features 411 (e.g., included in feature vectors) into a common space. Variable α_{i,j} represents an attention coefficient calculated for nodes 604, 606 (nodes i, j), and variable a represents an activation function configured to introduce non-linearity into the spatial feature vector hᵢ. The spatial feature vector may be propagated through layers, l, of GNN 426 through application of the following equation:

$${h}_{i}^{l} = σ ( {\sum }_{j ∈ {N}_{i}} {α}_{i , j}^{l} {W}^{l} {h}_{j}^{( l - 1 )} ) .$$

In this manner, processor 404 may be configured to generated learned spatial features, and processor 404 may store the learned spatial features in memory 406 as learned features 412.

Additionally, during spatial encoding 530, 630, processor 404 may determine attention coefficients for one or more pairs of nodes of plurality of nodes 604-610, such as pair of nodes 604 (e.g., node i), 606 (node j), based on the following equation:

$${α}_{i , j} = \frac{exp ( LeakyReLU ( {a}^{T} [ {Wx}_{i} ‖ {Wx}_{j} ] ) )}{{\sum }_{m ∈ {N}_{i}} exp ( LeakyReLU ( {a}^{T} [ {Wx}_{i} ‖ {Wx}_{m} ] ) )} .$$

In the foregoing equation, Nᵢ represents the set of spatial neighbors of node 604 (e.g., node i) in graph representation 528, 630. The variables xᵢ, xⱼ, and xₘ represent the feature vectors of nodes 604 (node i), 606 (node j), and 608 (node m), respectively. The variable W represents a learnable matrix configured to transform encoded features 411 (e.g., included in feature vectors) into a common space. The variable a represents a learnable weight vector.

In some implementations, to obtain temporal features by propagating temporal data, indicating the temporal relationship, through or based on the GNN via stacked layers of a temporal convolution network (TCN), processor 404 may be configured to apply a TCN that implements a one dimensional (1D) convolution operation to capture temporal dependencies encoded in edges 612-620. For example, processor 404 may be configured to apply the 1D convolution operation to features associated with each node 604-610 and to apply a non-linear activation function as follows:

$${h}_{i}^{l} ( t ) = σ ( {W}^{( l )} * {h}_{i}^{( l - 1 )} ( t ) + {b}^{( l )} ) .$$

In the foregoing, hᵢ^{l}(t) represents a temporal feature vector of node 604″(e.g., node i) at layer l and time t. The * operator represents a 1D convolution operation. W^{(l)} represents a weight tensor that processor 404 applies in performing the convolution operation. The variable b^{(l)} represents a learnable bias vector. The variable a represents an activation function (e.g., a non-linear function) to introduce non-linearities. In some implementations, processor 404 may be configured to stack multiple TCN layers to capture temporal dependencies at different time scales as follows:

$${h}_{i}^{l} ( t ) = σ ( {W}^{( l )} * {h}_{i}^{( l - 1 )} ( t ) + {b}^{( l )} ) + {U}^{( l )} \cdot {h}_{i}^{( l - 1 )} ( t - 1 ) + {V}^{( l )} \cdot {h}_{i}^{( l - 1 )} ( t - 1 ) ) .$$

In the foregoing equation, U^{(l)} and V^{(l)} include or correspond to learnable weight matrices through which processor 404 may be configured to capture temporal dependencies based on time stamps included in sensor data 432, 434. The temporal dependencies may include or correspond to learned temporal features and may be stored in memory 406 as learned features 412.

In some implementations, processor 404 may be configured to perform pooling operation 534, 634. For example, processor 404 may be configured to generate pooled features, such as pooled features 414, by combining the spatial learned features and the temporal learned features based on a second GAT. To illustrate, processor 404 may be configured to generate an attention weight for each node 604′″-610′″ based on a determined importance of each node 604′″-610′″ in predicting a 3D bounding box associated with an object to be identified, to be tracked over time, or both. Processor 404 may determine the attention weight based on the following equation:

$${α}_{i , j}^{( l )} = \frac{exp ( LeakyReLU ( {a}^{( l )} [ {W}^{( l )} {h}_{i}^{( l )} \vert {W}^{( l )} {h}_{j}^{( l )} ] ) )}{{\sum }_{m ∈ {N}_{i}} exp ( LeakyReLU ( {a}^{( l )} [ {W}^{( l )} {h}_{i}^{( l )} \vert {W}^{( l )} {h}_{m}^{( l )} ) ) ] ) )} .$$

In the foregoing, α_{i,j}^{(l)} represents the attention weight of node 606′″(e.g., node j) with respect to node 604′″(e.g., node i) at layer l. The variables hᵢ^{(l)} and hⱼ^{(l)} represent, respectively, feature vectors associated with nodes 604′″ and 606′″ at layer l. The variable a^{(l)} represents a learnable weight vector. The variable W^{(l)} corresponds to a learnable weight matrix to transform feature vectors hᵢ^{(l)} and hⱼ^{(l)}. The variable Nᵢ represents the set of nodes neighboring node 604′″(e.g., node i). For example, Nᵢ may include or correspond to nodes 606′″(e.g., node j), 608′″(e.g., node k), and 610′″(e.g., node m). Processor 404 may be configured to determine a pooled feature vector, zⱼ^{(l)}, constituting a weighted sum of feature vectors of all nodes 604′″-610′″ based on the following equation:

$${z}_{j}^{( l )} = {\sum }_{i ∈ {N}_{j}} {α}_{i , j}^{( l )} {h}_{i}^{( l )} .$$

Further, processor 404 may be configured to decode a 3D bounding box of an object to be identified, an object to be tracked over time, or both via a fully connected layer 536 based on the following equation:

$$b = FC ( concat ( {z}_{j}^{( l )} \vert t ) ) ) .$$

In the foregoing, the variable b represents the decoded 3D bounding box of the object, and concat includes or corresponds to a function that concatenates pooled feature vector zⱼ^{(l)} with a time stamp of a last frame in a sequence. FC includes or corresponds to a fully connected layer, such as fully connected layer 538, that maps a concatenated feature vector to the 3D bounding box.

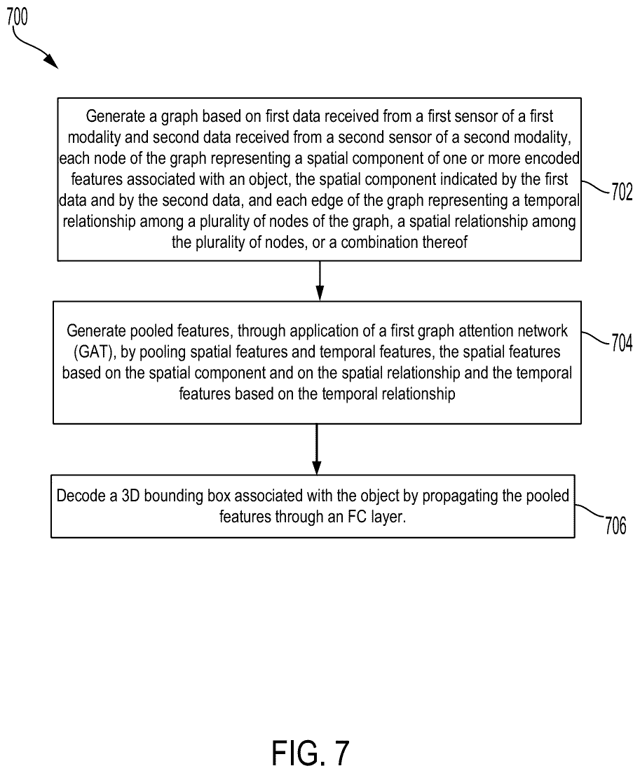

FIG. 7 is a flow diagram illustrating an example process 700 that supports GNN implemented multi-modal spatiotemporal fusion according to one or more aspects. Operations of process 700 may be performed by image signal processor 412, processor 404, or both. Example operations (also referred to as “blocks”) of process 700 may enable processing system 480 or components thereof to support GNN implemented multi-modal spatiotemporal fusion.

At block 702, a processing system or component thereof is configured to generate a graph based on first data received from a first sensor of a first modality and second data received from a second sensor of a second modality. For example, processor 404 may be configured to generate a graph, such as graph representation 528, 602, based on sensor data 432 received from sensor 401 and based on sensor data 434 received from sensor 402. Sensor 401 may be of a first modality, while sensor 402 may be of a second modality distinct from the first modality. For instance, sensor 401 may be configured to capture one or more LiDAR point clouds 532, while sensor 402 may be configured to capture on or more pixelated images 534. Each node of the graph represents a spatial component of one or more encoded features associated with an object, the spatial component indicated by the first data and by the second data. Additionally, the object may include or correspond to an object in images captured by an image processing system of the vehicle. For example, nodes 604-610 may each represent a spatial component of one or more encoded features, such as concatenated BEV features, generated through feature concatenation operation 514. The spatial component may include or correspond to a position in 3D space of the one or more encoded features associated with the object. In some implementations, features (e.g., concatenated BEV features) may be encoded in or stored in a feature vector associated with each node 604-610.

Additionally, each edge of the graph represents a temporal relationship among a plurality of nodes of the graph, a spatial relationship among the plurality of nodes, or a combination thereof. For example, edges 612-620 may encode information about spatial relationships among nodes 604-610, temporal relationships among nodes 604-612, or a combination thereof.

At block 704, the processing system or component thereof is configured to generate pooled features, through application of a first GAT, by pooling spatial features and temporal features. The spatial features may be based on the spatial component and on the spatial relationship and the temporal features may be based on the temporal relationship. For example, processor 404 may be configured to generate pooled features 414 based on pooling operation 534, 634. To illustrate, processor 404 may be configured to pool learned spatial features and learned temporal features, stored in memory 406 as learned features 412, to generate pooled features 414. The learned spatial features may be based on the spatial component and on the spatial relationship, and the temporal features may be based on the temporal relationship.

At block 706, the processing system or component thereof is configured to decode a 3D bounding box associated with the object by propagating the pooled features through a fully connected (FC) layer. For example, based on a pooled feature vector, determined or derived, by processor 404, based on pooled features 414, processor 404 may be configured to decode a 3D bounding box associated with the object. Based on decoding the 3D bounding box, an object may be identified, tracked over time, or both.

In some implementations, the first sensor, the second sensor, or both are incorporated into the vehicle. For example, sensor 401, sensor 402, or both may be incorporated into vehicle 100. However, in other implementations, sensor 401, sensor 402, or both may wirelessly communicate sensor data 432, 434 to vehicle 100 and may be incorporated into infrastructure, such as a road on which vehicle 100 may travel.

In some implementations, the processing system or component thereof may be configured to generate the spatial features. Additionally, in some implementations, to generate the spatial features, the processing system or component thereby may be configured to propagate the spatial component and spatial data through a GNN via stacked layers of a second GAT. The spatial data may indicate the spatial relationship, and the spatial data may be extracted from one or more edges of the graph. For instance, processor 404 may be configured to apply spatial encoding 530, 630 to obtain or derive learned spatial features by propagating the spatial component of nodes 604-610 and spatial data associated with edges 612-620 through instantiated GNN 426 via stacked layers of second instantiated GAT 428. The spatial data associated with edges 612-620 and extracted by processor 404 may encode the spatial relationship among nodes 604-610.

In some implementations, the processing system or component thereof may be configured to generate the temporal features. Additionally, in some implementations, to generate the temporal features, the processing system or component thereof may be configured to propagate temporal data through the GNN via stacked layers of the temporal convolution network (TCN). The temporal data may indicate the temporal relationship, and the temporal data may be extracted (e.g., by the processing system or component thereof) from one or more edges of the graph. For example, processor 404 may be configured to obtain or derive learned temporal features by propagating temporal data, such as may be encoded in edges 612-620 and that may indicate a temporal relationship among nodes 604-610, through GNN 426 via stacked layers of TCN 430. Additionally, processor 404 may be configured to extract temporal data from edges 612-620, the temporal data indicating a temporal relationship among nodes 604-610.

In some implementations, the first sensor includes a LiDAR sensor. For example, sensor 401 or sensor 402 may include or correspond to a LiDAR sensor. In some implementations, the first sensor is of a first modality such that the first sensor is configured to capture LiDAR point cloud data. For instance, sensor 401 may be configured to capture sensor data 432 that include or corresponds to LiDAR point cloud data 532. Additionally, in some implementations, the first data include a LiDAR point cloud. For instance, sensor data 432 may include or correspond to one or more LiDAR point clouds 532. In some implementations, the second sensor may include an image capture device, such as a camera. For example, sensor 402 may include or correspond to an image capture device, such as a camera. In some implementations, the second sensor is of a second modality such that the second sensor may be configured to capture pixelated images. For instance, sensor 402 may be configured to capture sensor data 434 that includes or corresponds to pixelated images 534.

In some implementations, to generate the pooled features, the processing system or component thereof may be configured to generate a pooled feature vector, the pooled feature vector based on each feature vector of each node of the plurality of nodes. For example, processor 404 may be configured to generate a pooled feature vector, such as pooled feature vector zⱼ^{(l)}, based on feature vectors, hᵢ^{(l)}-hₘ^{(l)}, associated with each node 604′-610′″ and based on an attention weight determined for each node 604′″-610′″. In some implementations, the feature vector includes the first data corresponding to LiDAR data and the second data corresponding to pixelated image data. For instance, feature vectors associated with any of nodes 604-604′″ through 610-610′″ may include sensor data 432, such as LiDAR data, and sensor data 434, such as pixelated image data.

In some implementations, the one or more encoded features include first BEV features associated with the first data and second BEV features associated with the second data. For example, first BEV features may include or correspond to LiDAR BEV features, and second BEV features may include or correspond to camera BEV features 526.

Additionally, in some implementations, the processing system or component thereof may be configured to identify the object based on the 3D bounding box, track the object over a period of time based on the 3D bounding box, or a combination thereof. For example, processor 404 may, based on bounding box data 415, identify the object, track the object over a period of time, or a combination thereof.

In some implementations, the spatial features indicate one or more spatial differences among the plurality of nodes. For example, learned spatial features may indicate that nodes 604′ and 606′ differ from one another spatially (e.g., may represent different spatial components of an imaged object), even though feature vectors associated with those nodes may be captured at the same instance of time and may not differ from one another temporally. In some implementations, the temporal features indicate one or more temporal differences among the plurality of nodes. For instance, nodes 604″ and 606″ may indicate features captured at different instances of time (e.g., having different time stamps) but that may correspond to spatially identical components of the object to be identified, to be tracked over time, or both.

In some implementations, to decode the 3D bounding box, the processing system or component thereof may be configured to generate 3D bounding box outputs based on the pooled features. Additionally, in some implementations, the 3D bonding box outputs may include a center location and a size of the 3D bounding box. For example, processor 404 may be configured to decode the 3D bounding box by generating 3D bounding box outputs 538 based on pooled features 414 by determining a pooled feature vector. In some implementations, the size of the 3D bounding box includes a width, a length, and a depth of the bounding box. Processor 404 may be configured to store the center location and size associated with the 3D bounding box as bounding box data 415.

In some implementations, a feature vector is associated with each node of the plurality of nodes. For example, features vectors xᵢ(t)-xₘ(t) may be associated with nodes 604-610. A feature vector may include data corresponding to features associated with the object to be identified, to be tracked over time, or both. Such data may correspond to or include spatial data, temporal data, or a combination thereof. As another example, spatial feature vectors hᵢ-hₘ may be associated with nodes 604′-610′ and may be determined based spatial encoding 530, 630. Further, temporal feature vectors hᵢ^{l} (t)-hₘ^{l} (t) may be associated with each node 604″-610″ and may be determined based on temporal encoding 532, 632.

In some implementations, the processing system or component thereof is further configured to generate the spatial features. For instance, processor 404 may be configured to generate learned spatial features. Additionally, in some implementations, to generate the spatial features, the processing system or component thereof is configured to propagate the spatial component and spatial data through a graph neural network (GNN) via stacked layers of a second GAT. For instance, processor 404 may be configured to propagate the spatial component and spatial data through instantiated GNN 426 via stacked layers of instantiated GAT 428. The spatial data may indicate the spatial relationship, and the processing system or component thereof may extract the spatial data from one or more edges of the graph. For example, processor 404 may be configured to extract spatial data, indicating the spatial relationship among nodes 604-610 from edges 612-620 of graph 602.

In some implementations, to propagate the spatial component and the spatial data through the GNN via the stacked layers of the second GAT, the processing system or component thereof may be configured to determine an attention coefficient for one or more pairs of nodes of the plurality of nodes. For example, processor 404 may be configured to determine attention coefficients for one or more pairs of nodes of plurality of nodes 604-610, such as pair of nodes 604 (e.g., node i), 606 (node j), based on the following equation:

$${α}_{i , j} = \frac{exp ( LeakyReLU ( {a}^{T} [ {Wx}_{i} ‖ {Wx}_{j} ] ) )}{{\sum }_{m ∈ {N}_{i}} exp ( LeakyReLU ( {a}^{T} [ {Wx}_{i} ‖ {Wx}_{m} ] ) )} .$$

In some implementations, to propagate the spatial component of the encoded feature and the spatial data through the GNN via the stacked layers of the first GAT, the processing system or component thereof may be configured to determine a spatial feature vector for one or more nodes of the plurality of nodes based on the attention coefficient and the feature vector. For example, processor 404 may be configured to determine spatial feature vector, hᵢ, for node 604′ (e.g., node i) based on the equation hᵢ=σ(Σ_{j∈N}_{ᵢ} α_{i,j}Wxⱼ).

In some implementations, to propagate the spatial component and the spatial data through the GNN, the processing system or component thereof may be configured to stack multiple GAT layers to propagate the spatial component of the encoded feature and the spatial data through a hierarchy of the GNN. For example, processor 404 may be configured to stack multiple GAT layers, such as GATT 428, to propagate the spatial component of the encoded feature and the spatial data through a hierarchy of GNN 426, based on the following equation:

$${h}_{i}^{l} = σ ( {\sum }_{j ∈ {N}_{i}} {α}_{i , j}^{l} {W}^{l} {h}_{j}^{( l - 1 )} ) .$$

In some implementations, the processing system or component thereof is further configured to generate the temporal features. For example, processor 404 may be configured to generate learned temporal features. Additionally, in some implementations, to generate the temporal features, the processing system of component thereof is configured to propagate the temporal data, indicating the temporal relationship, through a graph neural network (GNN) via stacked layers of a temporal convolution network (TCN). For instance, processor 404 may be configured to propagate temporal data, such as extracted from edges 612-620 of graph 602, through instantiated GNN 426 via stacked layers of instantiated TCN 430. Additionally, in some implementations, to propagate the temporal data through the GNN, the processing system or component thereof is configured to apply one dimensional convolution to one or more feature vectors associated with each node of the plurality of nodes. For example, processor 404 may be configured to apply one dimensional convolution to one or more feature vectors, hᵢ^{(l-t)})(t), associated with each node of the plurality of nodes 604″-610″, as follows:

$${h}_{i}^{l} ( t ) = σ ( {W}^{( l )} * {h}_{i}^{( l - 1 )} ( t ) + {b}^{( l )} ) .$$

In some implementations, to propagate the temporal data, indicating the temporal relationship, through the GNN via the stacked layers of the TCN, the processing system or component thereof is configured to stack multiple TCN layers to capture temporal dependencies at different time scales. For instance, processor 404 may be configured to achieve the foregoing based on the following equation:

$${h}_{i}^{l} ( t ) = σ ( {W}^{( l )} * {h}_{i}^{( l - 1 )} ( t ) + {b}^{( l )} ) + {b}^{( l )} + {U}^{( l )} \cdot {h}_{i}^{( l - 1 )} ( t - 1 ) + {V}^{( l )} \cdot {h}_{i}^{( l - 1 )} ( t - 1 ) ) .$$

In some implementations, to pool, through the first GAT, the spatial features and the temporal features, the processing system or component thereof is configured to determine an attention weight for each node at each layer, the attention weight indicative of an importance of each node to predict the 3D bounding box. For example, processor 404 may be configured to determine the attention weight based on the following equation:

$${α}_{i , j}^{( l )} = \frac{exp ( LeakyReLU ( {a}^{( l )} [ {W}^{( l )} {h}_{i}^{( l )} \vert {W}^{( l )} {h}_{j}^{( l )} ] ) )}{{\sum }_{m ∈ {N}_{i}} exp ( LeakyReLU ( {a}^{( l )} [ {W}^{( l )} {h}_{i}^{( l )} \vert {W}^{( l )} {h}_{m}^{( l )} ) ) ] ) )} .$$

In some implementations, to pool, through the first GAT, the spatial features and the temporal features, the processing system or component thereof is configured to determine a weighted sum of feature vectors associated with each node based on the attention weight associated with each node. For example, processor 404 may be configured to determine the weighted sum zⱼ^{(l)} of pooled feature vectors, such as pooled feature vector hᵢ^{(l)}, as follows:

zⱼ^{(l)}=Σ_{i ∈N}_{ⱼ}α_{i,j}^{(l)}hᵢ^{(l)}.

In some implementations, each feature vector of the feature vectors stores first sensor data and second sensor data related to a feature associated with a node. For instance, feature vectors xᵢ(t)-xₘ(t) associated with nodes 604-610 may store feature data extracted from or associated with first sensor data 432 and extracted from or associated with second sensor data 434.

It is noted that one or more blocks (or operations) described with reference to FIG. 7 may be combined with one or more blocks (or operations) described with reference to another of the figures. For example, one or more blocks (or operations) of FIG. 7 may be combined with one or more blocks (or operations) of any one or more of FIG. 1-6.

In one or more aspects, techniques for supporting vehicular operations may include additional aspects, such as any single aspect or any combination of aspects described below or in connection with one or more other processes or devices described elsewhere herein. In a first aspect, techniques for supporting GNN implemented multi-modal spatiotemporal fusion may include generating a graph based on first data received from a first sensor of a first modality and second data received from a second sensor of a second modality. Each node of the graph represents a spatial component of one or more encoded features associated with an object to be identified, the objected to be tracked over time, or both, the spatial component indicated by the first data and by the second data. Each edge of the graph represents a temporal relationship among a plurality of nodes of the graph, a spatial relationship among the plurality of nodes, or a combination thereof. The technique may further include generating pooled features, through application of a first graph attention network (GAT), by pooling spatial features and temporal features. The spatial features may be based on the spatial component and the spatial relationship, and the temporal features may be based on the temporal relationship. The technique may further include decoding a three dimensional (3D) bounding box associated with the object by propagating the pooled features through a fully connected (FC) layer. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the technique further includes generating the spatial features.

In a third aspect, in combination the one or more of the first aspect or the second aspect, generating the spatial features includes propagating the spatial component and spatial data through a graph neural network (GNN) via stacked layers of a second GAT, the spatial data indicating the spatial relationship, and the spatial data extracted from one or more edges of the graph.

In a fourth aspect, in combination with one or more of the first aspect through the third aspect, the technique further includes generating the temporal features.

In a fifth aspect, in combination with one or more of the first aspect through the fourth aspect, generating the temporal features includes propagating temporal data through the GNN via stacked layers of a temporal convolution network (TCN), the temporal data indicating the temporal relationship, and the temporal data extracted from the one or more edges of the graph.

In a sixth aspect, in combination with one or more of the first aspect through the fifth aspect, the first sensor includes a light detection and ranging (LiDAR) sensor.

In a seventh aspect, in combination with one or more of the first aspect through the sixth aspect, the first modality includes capturing LiDAR point cloud data.

In an eighth aspect, in combination with one or more of the first aspect through the seventh aspect, the first data includes a LiDAR point cloud.

In a ninth aspect, in combination with one or more of the first aspect through the eighth aspect, the second sensor includes a camera.

In a tenth aspect, in combination with one or more of the first aspect through the ninth aspect, the second modality includes capturing pixelated image data.

In an eleventh aspect, in combination with one or more of the first aspect through the tenth aspect, the second data includes pixelated images.

In a twelfth aspect, in combination with one or more of the first aspect through the eleventh aspect, generating the pooled features includes generating a pooled feature vector, the pooled feature vector based on each feature vector of each node of the plurality of nodes.

In a thirteenth aspect, in combination with the twelfth aspect, the feature vector includes the first data corresponding to light detection and ranging (LiDAR) data and the second data corresponding to pixelated image data.

In a fourteenth aspect, in combination with one or more of the first aspect through the thirteenth aspect, the one or more encoded features include first bird's eye view (BEV) features associated with the first data and second BEV features associated with the second data.

In a fifteenth aspect, in combination with one or more of the first aspect through the fourteenth aspect, the technique further includes identifying the object based on the 3D bunding box, tracking the object over a period of time based on the 3D bounding box, or a combination thereof.

In a sixteenth aspect, in combination with one or more of the first aspect through the fifteenth aspect, the spatial features indicate one or more spatial differences among the plurality of nodes.

In a seventeenth aspect, in combination with one or more of the first aspect through the sixteenth aspect, the temporal features indicate one or more temporal differences among the plurality of nodes.

In an eighteenth aspect, in combination with one or more of the first aspect through the seventeenth aspect, decoding the 3D bounding box includes generating 3D bounding box outputs based on the pooled features.

In a nineteenth aspect, in combination with the eighteenth aspect, the 3D bounding box outputs include a center location and a size of the 3D bounding box.

In a twentieth aspect, in combination with the nineteenth aspect, the size of the 3D bounding box includes a width, a length, and a depth of the bounding box.

In a twenty-first aspect, in combination with one or more of the first aspect through the twentieth aspect, a feature vector is associated with each node of the plurality of nodes.

In twenty-second aspect, in combination with one or more of the first aspect through the twenty-first aspect, the technique further includes generating the spatial features.

In a twenty-third aspect, in combination with the twenty-second aspect, generating the spatial features includes propagating the spatial component and the spatial data through a graph neural network (GNN) via the stacked layers of a second GAT.

In a twenty-fourth aspect, in combination with one or more of the twenty-second aspect or the twenty-third aspect, the spatial data indicates the spatial relationship.

In a twenty-fifth aspect, in combination with one or more of the twenty-second aspect through the twenty-fourth aspect, the spatial data is extracted from one or more edges of the graph.

In a twenty-sixth aspect, in combination with one or more of the twenty-third aspect through the twenty-fifth aspect, propagating the spatial component and the spatial data through the GNN via the stacked layers of the second GAT further includes determining an attention coefficient for one or more pairs of nodes of the plurality of nodes.

In a twenty-seventh aspect, in combination with one or more of the twenty-third aspect through the twenty-sixth aspect, propagating the spatial component and the spatial data through the GNN via the stacked layers of the first GAT further includes determining a spatial feature vector for the one or more nodes of the plurality of nodes based on the attention coefficient and the feature vector.

In a twenty-eighth aspect, in combination with the twenty-seventh aspect, propagating the spatial component and the spatial data through the GNN further includes stacking multiple GAT layers to propagate the spatial component and the spatial data through a hierarchy of the GNN.

In a twenty-ninth aspect, in combination with one or more of the first aspect through the twenty-eighth aspect, the technique includes generating the temporal features.

In a thirtieth aspect, in combination with the twenty-ninth aspect, generating the temporal features includes propagating temporal data, indicating the temporal relationship, through a graph neural network (GNN) via the stacked layers of a temporal convolution network (TCN).

In a thirty-first aspect, in combination with the thirtieth aspect, propagating the temporal data through the GNN includes applying one dimensional convolution to one or more feature vectors associated with each node of the plurality of nodes.

In a thirty-second aspect aspect, in combination with one or more of the thirtieth aspect or the thirty-first aspect, propagating the temporal data through the GNN includes stacking multiple TCN layers to capture temporal dependencies at different time scales.

In a thirty-third aspect, in combination with one or more of the first aspect through the thirty-second aspect, pooling, through the first GAT, the spatial features and the temporal features includes determining an attention weight for each node at each layer, the attention weight indicative of an importance of each node to predict the 3D bounding box.

In a thirty-fourth aspect, in combination with one or more of the first aspect through the thirty-third aspect, pooling, through the first GAT, the spatial features and the temporal features includes determining a weighted sum of feature vectors associated with each node based on the attention weight associated with each node.

In a thirty-fifth aspect, in combination with the thirty-fourth aspect, each feature vector of the feature vectors stores first sensor data and second sensor data related to a feature associated with a node.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
generating a graph based on first data received from a first sensor of a first modality and second data received from a second sensor of a second modality, each node of the graph representing a spatial component of one or more encoded features associated with an object, the spatial component indicated by the first data and by the second data, and each edge of the graph representing a temporal relationship among a plurality of nodes of the graph, a spatial relationship among the plurality of nodes, or a combination thereof;
generating pooled features, through application of a first graph attention network (GAT), by pooling spatial features and temporal features, wherein the spatial features are based on the spatial component and on the spatial relationship and the temporal features are based on the temporal relationship; and
decoding a three dimensional (3D) bounding box associated with the object by propagating the pooled features through a fully connected (FC) layer.

2. The method of claim 1, further comprising:
generating the spatial features, wherein generating the spatial features includes propagating the spatial component and spatial data through a graph neural network (GNN) via stacked layers of a second GAT, the spatial data indicating the spatial relationship, and the spatial data extracted from one or more edges of the graph; and
generating the temporal features, wherein generating the temporal features includes propagating temporal data through the GNN via stacked layers of a temporal convolution network (TCN), the temporal data indicating the temporal relationship, and the temporal data extracted from the one or more edges of the graph.

3. The method of claim 1, wherein:
the first sensor includes a light detection and ranging (LiDAR) sensor,
the first modality includes capturing LiDAR point cloud data,
the first data includes a LiDAR point cloud,
the second sensor includes a camera,
the second modality includes capturing pixelated image data, and
the second data includes pixelated images.

4. The method of claim 1, wherein generating the pooled features includes generating a pooled feature vector, the pooled feature vector based on each feature vector of each node of the plurality of nodes, and
the feature vector includes the first data corresponding to light detection and ranging (LiDAR) data and the second data corresponding to pixelated image data.

5. The method of claim 1, wherein the one or more encoded features include first bird's eye view (BEV) features associated with the first data and second BEV features associated with the second data, and wherein the method further comprises:
identifying the object based on the 3D bounding box,
tracking the object over a period of time based on the 3D bounding box, or
a combination thereof.

6. The method of claim 1, wherein the spatial features indicate one or more spatial differences among the plurality of nodes, and wherein the temporal features indicate one or more temporal differences among the plurality of nodes.

7. The method of claim 1, wherein decoding the 3D bounding box includes generating 3D bounding box outputs based on the pooled features, and wherein the 3D bounding box outputs include a center location and a size of the 3D bounding box.

8. The method of claim 7, wherein the size of the 3D bounding box includes a width, a length, and a depth of the 3D bounding box.

9. The method of claim 1, wherein a feature vector is associated with each node of the plurality of nodes, the method further comprising:
generating the spatial features, wherein generating the spatial features includes propagating the spatial component and spatial data through a graph neural network (GNN) via stacked layers of a second GAT, and wherein:
the spatial data indicates the spatial relationship,
the spatial data is extracted from one or more edges of the graph, and
propagating the spatial component and the spatial data through the GNN via the stacked layers of the second GAT further includes:
determining an attention coefficient for one or more pairs of nodes of the plurality of nodes; and
determining a spatial feature vector for one or more nodes of the plurality of nodes based on the attention coefficient and the feature vector.

10. The method of claim 9, wherein propagating the spatial component and the spatial data through the GNN further includes:
stacking multiple GAT layers to propagate the spatial component of the encoded feature and the spatial data through a hierarchy of the GNN.

11. The method of claim 1, further comprising:
generating the temporal features, wherein generating the temporal features includes propagating temporal data, indicating the temporal relationship, through a graph neural network (GNN) via stacked layers of a temporal convolution network (TCN), and wherein propagating the temporal data through the GNN includes:
applying one dimensional convolution to one or more feature vectors associated with each node of the plurality of nodes; and
stacking multiple TCN layers to capture temporal dependencies at different time scales.

12. The method of claim 1, wherein pooling, through the first GAT, the spatial features and the temporal features includes:
determining an attention weight for each node at each layer, the attention weight indicative of an importance of each node to predict the 3D bounding box; and
determining a weighted sum of feature vectors associated with each node based on the attention weight associated with each node, wherein each feature vector of the feature vectors stores first sensor data and second sensor data related to a feature associated with a node.

13. An apparatus, comprising:
a processing system, the processing system including one or more processors and one or more memories coupled with the one or more processors, the processing system configured to:
generate a graph based on first data received from a first sensor of a first modality and second data received from a second sensor of a second modality, each node of the graph representing a spatial component of one or more encoded features associated with an object, the spatial component indicated by the first data and by the second data, and each edge of the graph representing a temporal relationship among a plurality of nodes of the graph, a spatial relationship among the plurality of nodes, or a combination thereof;
generate pooled features, through application of a first graph attention network (GAT), wherein, to generate the pooled features, the processing system is configured to pool spatial features and temporal features, wherein the spatial features are based on the spatial component and on the spatial relationship and the temporal features are based on the temporal relationship; and
decode a three dimensional (3D) bounding box associated with the object by propagating the pooled features through a fully connected (FC) layer.

14. The apparatus of claim 13, wherein the processing system is further configured to:
generate the spatial features, wherein, to generate the spatial features, the processing system is configured to propagate the spatial component and spatial data, through a graph neural network (GNN) via stacked layers of a second GAT, the spatial data indicating the spatial relationship, and the spatial data extracted from one or more edges of the graph; and
generate the temporal features, wherein, to generate the temporal features, the processing system is configured to propagate temporal data through the GNN via stacked layers of a temporal convolution network (TCN), the temporal data indicating the temporal relationship, and the temporal data extracted from the one or more edges of the graph.

15. The apparatus of claim 13, wherein:
the first sensor includes a light detection and ranging (LiDAR) sensor,
the first modality includes capturing LiDAR point cloud data,
the first data includes a LiDAR point cloud,
the second sensor includes a camera,
the second modality includes capturing pixelated image data, and
the second data includes pixelated images.

16. The apparatus of claim 13, wherein, to generate the pooled features, the processing system is further configured to:
generate a pooled feature vector, the pooled feature vector based on each feature vector of each node of the plurality of nodes, and
the feature vector includes the first data corresponding to light detection and ranging (LiDAR) data and the second data corresponding to pixelated image data.

17. The apparatus of claim 13, wherein the one or more encoded features include first bird's eye view (BEV) features associated with the first data and second BEV features associated with the second data, and wherein the object is to be identified, to be tracked over a time period, or both.

18. The apparatus of claim 13, wherein the spatial features indicate one or more spatial differences among the plurality of nodes, and wherein the temporal features indicate one or more temporal differences among the plurality of nodes.

19. The apparatus of claim 13 wherein, to decode the 3D bounding box, the processing system is further configured to:
generate 3D bounding box outputs based on the pooled features, and wherein the 3D bounding box outputs include a center location and a size of the 3D bounding box.

20. The apparatus of claim 19, wherein the size of the 3D bounding box includes a width, a length, and a depth of the bounding box.

21. The apparatus of claim 13, wherein a feature vector is associated with each node of the plurality of nodes, and wherein the processing system is further configured to:
generate the spatial features, wherein, to generate the spatial features, the processing system is configured to propagate the spatial component and spatial data through a graph neural network (GNN) via stacked layers of a second GAT, wherein:
the spatial data indicates the spatial relationship,
the spatial data is extracted from one or more edges of the graph, and
to propagate the spatial component and the spatial data through the GNN via the stacked layers of the second GAT, the processing system is configured to:
determine an attention coefficient for one or more pairs of nodes of the plurality of nodes; and
determine a spatial feature vector for one or more nodes of the plurality of nodes based on the attention coefficient and the feature vector.

22. The apparatus of claim 21, wherein, to propagate the spatial component of the encoded feature and the spatial data through the GNN, the processing system is configured to:
stack multiple GAT layers to propagate the spatial component of the encoded feature and the spatial data through a hierarchy of the GNN.

23. A non-transitory computer-readable medium storing instructions that, when executed by a processor, cause the processor to perform operations comprising:
generating a graph based on first data received from a first sensor of a first modality and second data received from a second sensor of a second modality, each node of the graph representing a spatial component of one or more encoded features associated with an object, the spatial component indicated by the first data and by the second data, and each edge of the graph representing a temporal relationship among a plurality of nodes of the graph, a spatial relationship among the plurality of nodes, or a combination thereof;
generating pooled features, through application of a first graph attention network (GAT), by pooling spatial features and temporal features, wherein the spatial features are based on the spatial component and on the spatial relationship and the temporal features are based on the temporal relationship; and
decoding a three dimensional (3D) bounding box associated with the object by propagating the pooled features through a fully connected (FC) layer.

24. The non-transitory, computer-readable medium of claim 23, wherein the operations further comprise:
generating the temporal features, wherein generating the temporal features includes propagating temporal data, indicating the temporal relationship, through a graph neural network (GNN) via stacked layers of a temporal convolution network (TCN), and wherein propagating the temporal data through the GNN includes:
applying one dimensional convolution to one or more feature vectors associated with each node of the plurality of nodes; and
stacking multiple TCN layers to capture temporal dependencies at different time scales.

25. The non-transitory, computer-readable medium of claim 24, wherein pooling, through the first GAT, the spatial features and the temporal features includes:
determining an attention weight for each node at each layer, the attention weight indicative of an importance of each node to predict the 3D bounding box; and
determining a weighted sum of feature vectors associated with each node based on the attention weight associated with each node, wherein each feature vector of the feature vectors stores first sensor data and second sensor data related to a feature associated with a node.

26. A vehicle, comprising:
a first sensor of a first modality;
a second sensor of a second modality different from the first modality; and
a processing system that includes one or more processors and one or more memories coupled with the one or more processors, the processing system configured to:
generate a graph based on first data received from the first sensor and second data received from a second sensor, each node of the graph representing a spatial component of one or more encoded features associated with an object, the spatial component indicated by the first data and by the second data, and each edge of the graph representing a temporal relationship among a plurality of nodes of the graph, a spatial relationship among the plurality of nodes, or a combination thereof;
generate pooled features, through application of a first graph attention network (GAT), wherein, to generate the pooled features, the processing system is configured to pool spatial features and temporal features, wherein the spatial features are based on the spatial component and on the spatial relationship and the temporal features are based on the temporal relationship; and
decode a three dimensional (3D) bounding box associated with the object by propagating the pooled features through a fully connected (FC) layer.

27. The vehicle of claim 26, wherein the processing system is further configured to generate the spatial features, wherein, to generate the spatial features, the processing system is configured to propagate the spatial component and spatial data through a graph neural network (GNN) via stacked layers of a second GAT, the spatial data indicating the spatial relationship, and the spatial data extracted from one or more edges of the graph, wherein, to propagate the spatial component and the spatial data through the GNN, the processing system is configured to:
determine an attention coefficient for one or more pairs of nodes of the plurality of nodes;
determine a spatial feature vector for one or more nodes of the plurality of nodes based on the attention coefficient and a feature vector, the feature vector associated with the one or more nodes; and
stack multiple GAT layers to propagate the spatial component and the spatial data through a hierarchy of the GNN.

28. The vehicle of claim 26, wherein:
the processing system is further configured to generate the temporal features
to generate the temporal features, the processing system is configured to propagate temporal data, indicating the temporal relationship, through a graph neural network (GNN) via stacked layers of a temporal convolution network (TCN), and
to propagate the temporal data through the GNN, the processing system is configured to:
apply one dimensional convolution to one or more feature vectors associated with each node of the plurality of nodes; and
stack multiple TCN layers to capture temporal dependencies at different time scales.

29. The vehicle of claim 26, wherein, to pool, through the first GAT, the spatial features and the temporal features, the processing system is configured to:
determine an attention weight for each node at each layer, the attention weight indicative of an importance of each node to predict the 3D bounding box; and
determine a weighted sum of feature vectors associated with each node based on the attention weight associated with each node, wherein each feature vector of the feature vectors stores first sensor data and second sensor data related to a feature associated with a node.

30. The vehicle of claim 26, wherein the processing system is further configured to:
initiate an adjustment of a direction of travel of the vehicle based on the 3D bounding box.
